(19) United States
(12) Patent Application Publication
(10) Pub. No.: US 2021/0350704 A1
(43) Pub. Date: Nov. 11, 2021

(54) ALARM DEVICE, ALARM SYSTEM INCLUDING THE SAME, AND METHOD OF OPERATING THE SAME

(71) Applicant: Samsung Electronics Co., Ltd., Suwon-si (KR)

(72) Inventor: Dongil HYUN, Seongnam-si (KR)

(73) Assignee: Samsung Electronics Co., Ltd., Suwon-si (KR)

(21) Appl. No.: 17/108,345

(22) Filed: Dec. 1, 2020

(30) Foreign Application Priority Data
May 8, 2020 (KR) 10-2020-0054989

(51) Int. Cl. G08G 1/16; G01H 17/00; B60W 50/14

(52) U.S. Cl. CPC G08G 1/166; G01H 17/00; G08G 1/162; B60W 50/14; B60W 2554/4041; B60W 2050/143; B60W 2556/30; B60W 2554/4029; B60W 2420/54

(57) ABSTRACT

An alarm device configured to generate an alarm to a driver inside a vehicle, includes processing circuitry configured to generate delay time information based on a first reference level and at least a portion of sound source signals that are generated by a plurality of microphones in the vehicle based on a sound generated from outside of the vehicle. The processing circuitry is further configured to generate position parameters based on a second reference level and at least a portion of the delay time information. The processing circuitry is further configured to generate, based on the position parameters, candidate position information representing candidate positions on which the sound source is expected to be located, and generate final position information based on a third reference level and the candidate position information.

### CROSS-REFERENCE TO RELATED APPLICATION

This U.S. non-provisional application claims priority under 35 USC § 119 to Korean Patent Application No. 10-2020-0054989, filed on May 8, 2020, in the Korean Intellectual Property Office (KIPO), the disclosure of which is incorporated by reference herein in its entirety.

### BACKGROUND

### 1. Technical Field

Example embodiments relate generally to an alarm device and more particularly to an alarm device, an alarm system including an alarm device, and a method of operating an alarm device.

### 2. Discussion of the Related Art

With a recent rapid development of IT technology, interest in intelligent vehicles that are fused with advanced vehicle safety technologies is increasing. Advanced safety vehicle technologies such as a lane departure detection system, an inter-vehicle distance control system, a collision warning system, and a lane change control system are a basis of intelligent vehicle technology, and various research and technology developments have been conducted on them.

### SUMMARY

Some example embodiments may provide an alarm device, an alarm system including an alarm device, and method of operating an alarm device capable of more efficiently generating an alarm to a driver inside a vehicle.

According to example embodiments, an alarm device configured to generate an alarm to a driver inside a vehicle, includes, processing circuitry configured to generate delay time information based on a first reference level and at least a portion of sound source signals that are generated by a plurality of microphones in the vehicle based on a sound generated from outside (for example, outside the vehicle). The processing circuitry is further configured to generate position parameters based on a second reference level and at least a portion of the delay time information. The processing circuitry is further configured to generate, based on the position parameters, candidate position information representing candidate positions on which the sound source is expected to be located, and generate final position information based on a third reference level and the candidate position information.

According to example embodiments, an alarm system includes an alarm system server and one or more alarm system clients. The alarm system clients request a service to the alarm system server. Each of the alarm system clients includes an alarm device. The alarm device includes processing circuitry configured to generate delay time information based on a first reference level and at least a portion of sound source signals that are generated by a plurality of microphones in the vehicle based on a sound generated from outside (for example, outside the vehicle). The processing circuitry is further configured to generate position parameters based on a second reference level and at least a portion of the delay time information. The processing circuitry is further configured to generate, based on the position parameters, candidate position information representing candidate positions on which the sound source is expected to be located, and generates final position information based on a third reference level and the candidate position information.

According to example embodiments, in a method of generating an alarm to a driver inside a vehicle, delay time information is generated based on a first reference level and at least a portion of sound source signals. The sound source signals are generated by a plurality of microphones in the vehicle based on a sound generated from outside (for example, outside the vehicle). Position parameters are generated based on a second reference level and at least a portion of the delay time information. Candidate position information is generated based on the position parameters. The candidate position information represents candidate positions on which the sound source is expected. Final position information is generated based on a third reference level and the candidate position information.

The alarm device, the alarm system and the method according to example embodiments may adaptively send an alarm to the driver who boarded the vehicle according to the type of the sound source generated from outside (for example, outside the vehicle) using visual and audible devices. Therefore, the alarm device, the alarm system and the method allow the driver to drive more safely. Further, the alarm device, the alarm system and the method receive the first to third reference levels and select at least a portion of the corresponding signals or information based on each of the first to third reference levels. The alarm device, the alarm system and the method may reduce power consumption by performing subsequent processing for only a portion of the signals or the information according to the selection.

### BRIEF DESCRIPTION OF THE DRAWINGS

Example embodiments of the present disclosure will be more clearly understood from the following detailed description taken in conjunction with the accompanying drawings.

FIG. 1 is a block diagram illustrating an alarm device according to example embodiments.

FIG. 2 is a diagram for describing the alarm device of FIG. 1.

FIG. 3 is a block diagram illustrating an example embodiment of the sound source position estimator of FIG. 1.

FIG. 4 is a block diagram illustrating an example embodiment of the delay time information generator of FIG. 3.

FIGS. 5 and 6 are diagrams for describing a process of selecting at least a portion of sound source signals by the sound source signal provider of FIG. 4.

FIG. 7 is a diagram illustrating an example embodiment of an output value of GCC-PHAT calculated in a process of generating delay time information.

FIG. 8 is a block diagram illustrating an example embodiment of the position parameter generator of FIG. 3.

FIG. 9 is a diagram for describing a process of selecting at least a portion of delay time information by the delay time information receiver of FIG. 9.

FIG. 10 is a block diagram illustrating an example embodiment of the sound source position information generator of FIG. 3.

FIG. 11 is a diagram for describing a process of generating final position information by the final position information generator of FIG. 10.

FIG. 12 is a block diagram illustrating an example embodiment of the sound source reproducer of FIG. 1.

FIG. 13 is a diagram for describing a process of calculating an internal speaker gain.

FIG. 14 is a block diagram illustrating an alarm device according to example embodiments.

FIG. 15 is a block diagram illustrating an example embodiment of the sound source position estimator of FIG. 14.

FIG. 16 is a block diagram illustrating an example embodiment of the deviation information generator of FIG. 15.

FIG. 17 is a diagram for describing a process of selecting at least a portion of image signals by the deviation information generator of FIG. 16.

FIG. 18 is a diagram for describing a process of generating position parameters by the position parameter generator of FIG. 15 and a process of generating final position information by sound source position information generator of FIG. 15.

FIG. 19 is a block diagram illustrating an alarm device according to example embodiments.

FIG. 20 is a flowchart illustrating a method of operating an alarm device according to example embodiments.

FIGS. 21, 22 and 23 are diagrams for describing an example embodiment of a network structure used to perform deep learning for recognizing a type of sound source by an alarm device according to example embodiments.

FIG. 24 is a block diagram illustrating a client including an alarm device according to example embodiments.

FIG. 25 is a block diagram illustrating an alarm system including an alarm device according to example embodiments.

### DETAILED DESCRIPTION OF EXAMPLE EMBODIMENTS

Various example embodiments will be described more fully hereinafter with reference to the accompanying drawings, in which some example embodiments are shown. In the drawings, like numerals refer to like elements throughout. The repeated descriptions may be omitted.

Hereinafter, for convenience of description, a X-axis, a Y-axis and Z-axis that are orthogonal to each other are illustrated. The X-axis corresponds to a width direction of a vehicle, the Y-axis corresponds to a height direction of the vehicle, and the Z-axis corresponds to the length direction of the vehicle.

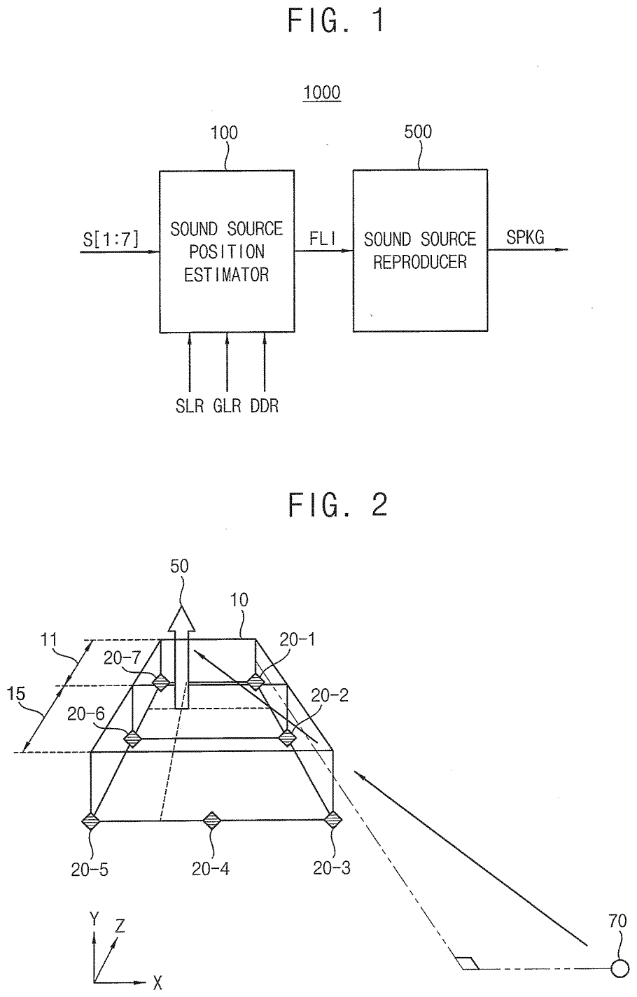

FIG. 1 is a block diagram illustrating an alarm device according to example embodiments. FIG. 2 is a diagram for describing the alarm device of FIG. 1.

Referring to FIGS. 1 and 2, the alarm device 1000 is installed inside a vehicle 10, and may generate an alarm to a driver 50 inside the vehicle 10 according to a type of a sound source 70 generated from outside of the vehicle 10. In some example embodiments, the alarm device 1000 may operate under a control of an electronic control unit (ECU) installed inside the vehicle 10, but the scope of the present inventive concepts is not limited thereto.

In FIG. 2, a front part 11 and a rear part 15 of the vehicle 10 are illustrated. A plurality of microphones 20-1 to 20-7 may be embedded at a bottom of left and right sides of the front part 11, at a bottom of boundary between the front part 11 and the rear part 15 and at a bottom of left, center and right sides of the rear part 15. But a number and embedded positions of the plurality of microphones 20-1 to 20-7 are examples, and the scope of the present inventive concepts is not limited thereto.

The alarm device 1000 includes a sound source position estimator 100 and a sound source reproducer 500.

The sound source position estimator 100 receives sound source signals S[1:7]. The sound source signals S[1:7] are generated by the plurality of microphones 20-1 to 20-7. The plurality of microphones 20-1 to 20-7 receive sound generated from the sound source 70 positioned outside the vehicle 10 to generate sound source signals S[1:7].

The sound source position estimator 100 receives a first reference level SLR, and generates delay time information based on at least a portion of the sound source signals S[1:7] and the first reference level SLR. The sound source position estimator 100 receives a second reference level GLR, and generates position parameters based on at least a portion of the delay time information and the second reference level GLR. The sound source position estimator 100 generates candidate position information representing candidate positions on which the sound source 70 is expected to be located. The sound source position estimator 100 receives a third reference level DDR, and generates final position information FLI based on at least a portion of the candidate position information and the third reference level DDR.

The sound source reproducer 500 receives the final position information FLI from the sound source position estimator 100. The sound source reproducer 500 adjusts an internal speaker gain SPKG based on the final position information FLI, and adaptively generates an alarm to the driver 50 using an internal speaker, a head-up display or an internal display device.

As described above, the alarm device 1000 adaptively send an alarm to the driver 50 who boarded the vehicle 10 according to the type of the sound source 70 generated from outside of the vehicle 10 using visual and audible devices. Therefore, the alarm device 1000 allows the driver 50 to drive safely. Further, the alarm device 1000 receives the first to third reference levels SLR, GLR and DDR, and selects at least a portion of the corresponding signals or information based on each of the first to third reference levels SLR, GLR and DDR. The alarm device 1000 may reduce power consumption by performing subsequent processing for only a portion of the signals or the information according to the selection. A detailed description will be described later.

FIG. 3 is a block diagram illustrating an example embodiment of the sound source position estimator of FIG. 1.

Referring FIGS. 1, 2 and 3, the sound source position 100 includes a delay time information generator 110, a position parameter generator 130 and/or a sound source position information generator 150.

The delay time information generator 110 receives the sound source signals S[1:7] from each of the plurality of microphones 20-1 to 20-7, and receives the first reference level SLR from outside (for example, outside the vehicle). The delay time information generator 110 generates selection sound signals by selecting at least a portion of the sound source signals S[1:7] based on the first reference level SLR. The delay time information generator 110 generates spectrum signals by converting the selection sound source signals into a frequency domain. The delay time information generator 110 generates delay time information TDOA by applying a delay time estimation algorithm to the spectrum signals.

The position parameter generator 130 receives the delay time information TDOA from the delay time information generator 110 and receives the second reference level GLR from outside (for example, outside the vehicle). The position parameter generator 130 generates selection delay time information by selecting at least a portion of the delay time information TDOA based on the second reference level GLR. The position parameter generator 130 generates position parameters PPRM for estimating the position of the sound source based on the selection delay time information.

The sound source position information generator 150 receives the position parameters PPRM from the position parameter generator 130 and receives the third reference level DDR from outside (for example, outside the vehicle). The sound source position information generator 150 generates candidate position information representing candidate positions on which the sound source is expected to located, based on the position parameters. The sound source position information generator 150 generates final position information FLI by selecting at least a portion of the candidate position information based on the third reference level DDR.

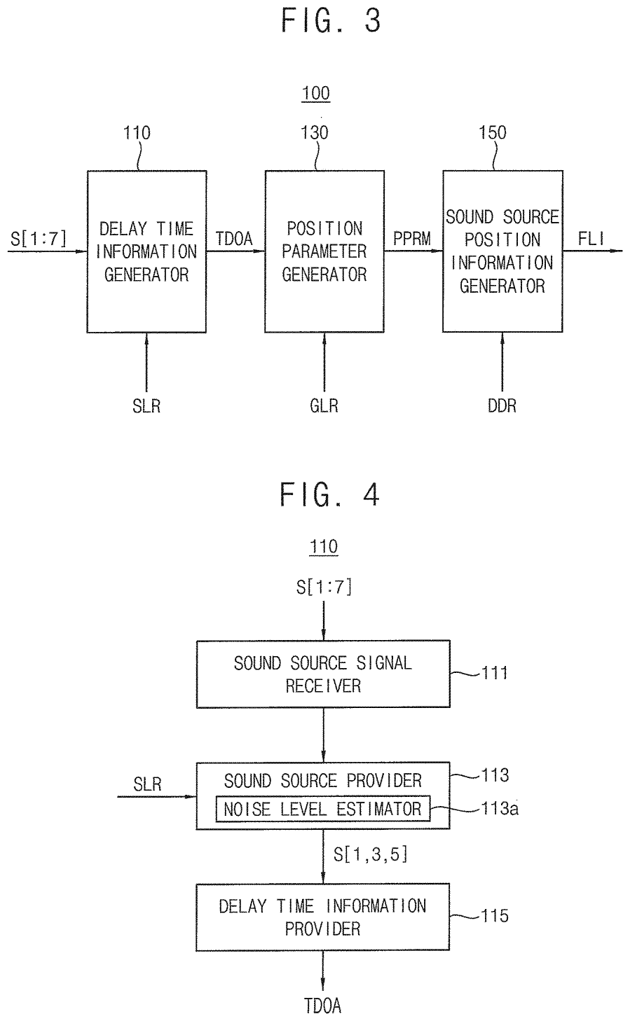

FIG. 4 is a block diagram illustrating an example embodiment of the delay time information generator of FIG. 3.

Referring to FIG. 4, the delay time information generator 110 includes a sound source signal receiver 111, a sound source signal provider 113 and/or a delay time information provider 115. The sound source provider may further include a noise level estimator 113a.

The sound source signal receiver 111 receives and stores the sound source signals S[1:7], and transmits the sound source signals to the sound source signal provider 113.

The sound source signal provider 113 receives sound source signals S[1:7] from the sound source signal receiver 111 and receives the first reference level SLR from outside (for example, outside the vehicle). The sound source signal provider 113 selects at least a portion of the sound source signals S[1:7] based on the first reference level SLR. Hereinafter, a detailed description will be described later.

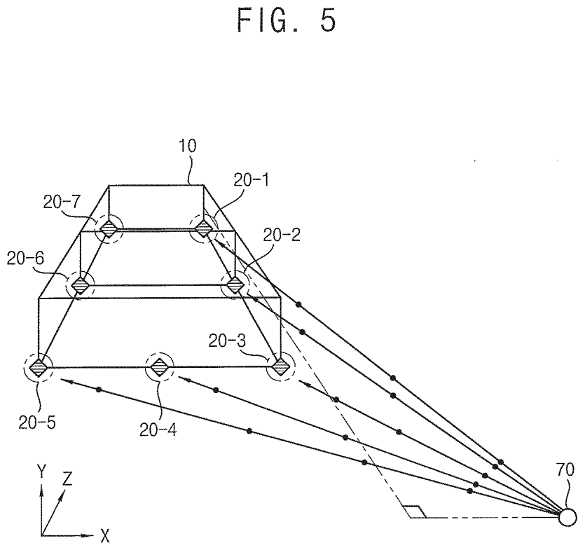

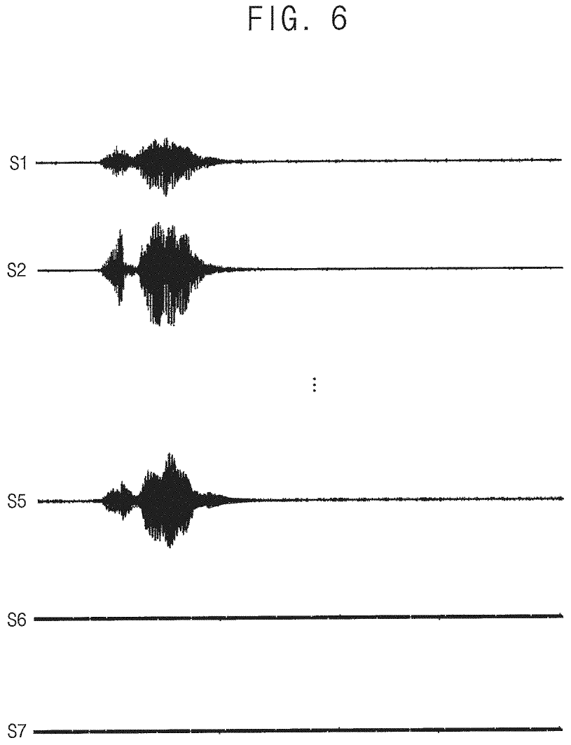

FIGS. 5 and 6 are diagrams for describing a process of selecting at least a portion of sound source signals by the sound source signal provider of FIG. 4.

Referring to FIGS. 5 and 6, each of the sound source signals S[1:7] may represent signal levels of different magnitudes due to noise around the vehicle 10 and relative positions of the sound source 70 and the plurality of microphones 20-1 to 20-7. For example, as illustrated in FIG. 5, when the sound source 70 is located near a right side of the rear part of vehicle 10, only a portion of the microphones 20-1 to 20-5 may generate sound source signals S[1:5]. In some example embodiments, the sound source signal provider 113 may select at least a portion of the sound source signal S[1:5] based on the first reference level SLR.

In some example embodiments, the first reference level SLR may be determined, predetermined or alternatively, desired based on strength of a siren or a horn sound of vehicles. In some example embodiments, the sound source signal provider 113 may select only sound source signals in which a maximum value of each of the sound source signals S[1:5] is greater than the first reference level SLR. In other example embodiments, the sound source signal provider 113 may select only sound source signal in which an average value of each of the sound source signals S[1:5] is greater than the first reference level SLR. But the scope of the present inventive concepts is not limited thereto. Furthermore, the sound source signal provider 113 may receive noise information representing a magnitude of noise around the vehicle 10 from the noise level estimator 113a, and may select only sound signals in which a magnitude of each of the sound source signals S[1:5] is greater than the magnitude of the noise. The noise level estimator 113a may generate the noise information based on signal components common to each of the sound source signals S[1:7].

Referring back to FIG. 4, the sound source signal provider 113 selects at least a portion of the sound source signals S[1:7] based on the first reference level SLR to generate selection sound source signals, for example, S[1,3,5]. The sound source signal provider 113 may transmit the selection sound source signals S[1,3,5] to the delay time information provider 115.

The delay time information provider 115 receives selection sound source signals S[1,3,5] from the sound source signal provider 113. The delay time information provider 115 may generate spectrum signals by converting the selection sound source signal S[1,3,5] into frequency domain. In some example embodiments, the conversion to the frequency domain is performed by performing time windowing on each of the selection sound source signals S[1,3,5], selecting two, for example, S[1,3], S[1,5] and S[3,5], of the selection sound source signals S[1,3,5], and performing a Short-Term Fourier transform (STFT) on the selected sound source signals, S[1,3], S[1,5] and S[3,5].

In addition, delay time information TDOA may be generated by applying a delay time estimation algorithm to the spectrum signals. Hereinafter, a detailed description will be described. In some example embodiments, the delay time estimation algorithm may be Generalized Cross Correlation-Phase Transform GCC-PHAT. An output value obtained by applying GCC-PHAT to the spectrum signals may be calculated according to Equation 1 and Equation 2 below.

$$\begin{matrix}{R}_{{x}_{1} {x}_{2}}^{( g )} ( τ ) = {\int }_{- ∞}^{∞} \frac{{G}_{{x}_{1} {x}_{2}} ( f )}{\vert {G}_{{x}_{1} {x}_{2}} ( f ) \vert} {e}^{j 2 f τ} df . & [ Equation 1 ] \\ {G}_{{x}_{1} {x}_{2}} ( f ) = {X}_{1} ( f ) {X}_{2}^{*} ( f ) & [ Equation 2 ]\end{matrix}$$

In equation 2, each of X₁(f) and X₂(f) is a result of performing the STFT on one of the selected sound source signals S[1,3], S[1,5] and S[3,5].

In addition, the delay time information TDOA may be generated by calculating τ to maximize the Rₓ_{₁}^{(g)}ₓ_{₂}(τ). The delay time information TDOA may be calculated according to Equation 3 below.

$${τ}_{max} = arg {max}_{τ} \{ {R}_{{x}_{1} {x}_{2}}^{( g )} ( τ ) \} \qquad [ Equation 3 ]$$

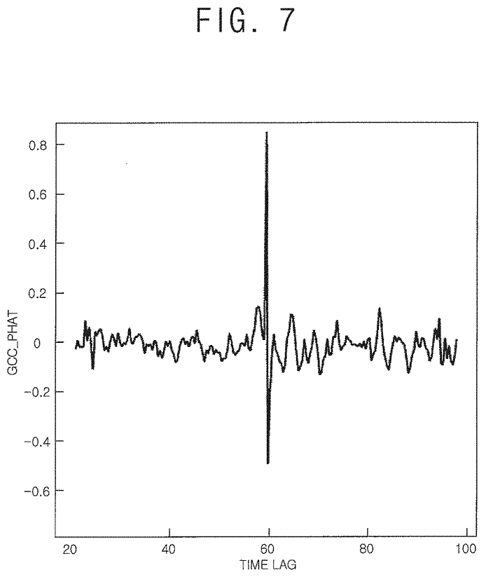

FIG. 7 is a diagram illustrating an example embodiment of an output value of GCC-PHAT calculated in a process of generating delay time information.

In FIG. 7, an output value obtained by applying the GCC-PHAT to signals, for example, S[1,3], is illustrated.

Referring to FIG. 7, with respect to signals S[1,3], the T that maximizes the Rₓ_{₁}^{(g)}ₓ_{₂}(τ) is 60, unit is [ms].

Referring back to FIGS. 3 and 4, the delay time information provider 115 generates delay time information TDOA and transmits the delay time information TDOA to the position parameter generator 130.

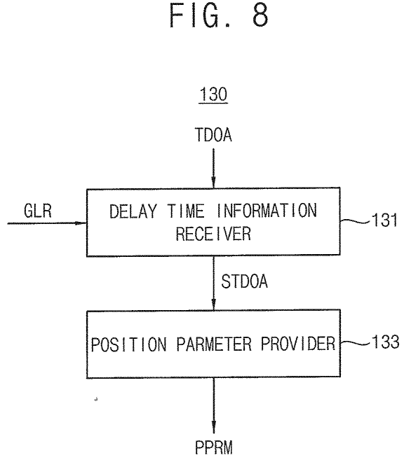

FIG. 8 is a block diagram illustrating an example embodiment of the position parameter generator of FIG. 3.

Referring to FIGS. 3 and 8, the position parameter generator 130 includes a delay time information receiver 131 and/or a position parameter provider 133.

The delay time information receiver 131 receives delay time information TDOA from the delay time information generator 110 and receives the second reference level GLR from outside (for example, outside the vehicle).

The delay time information receiver 131 selects a portion of the delay time information TDOA based on the second reference level GLR. Hereinafter, a detailed description will be described.

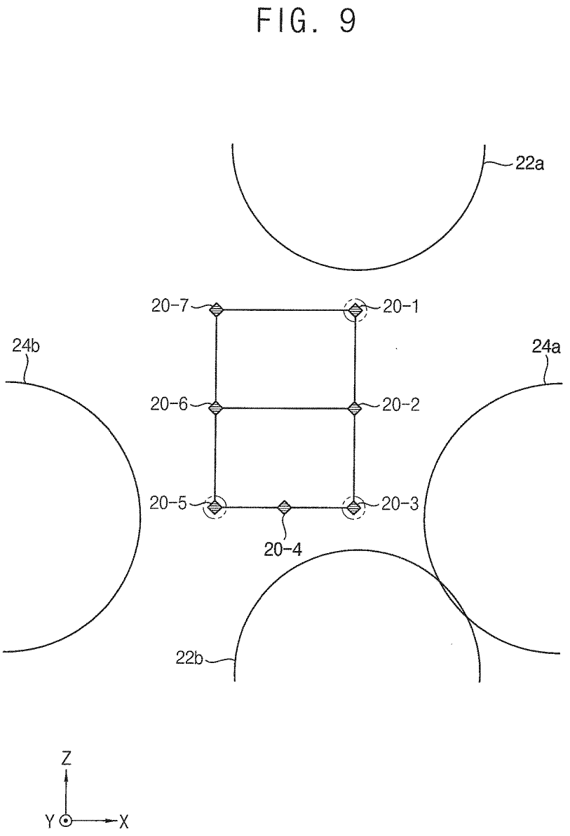

FIG. 9 is a diagram for describing a process of selecting at least a portion of delay time information by the delay time information receiver of FIG. 9.

Referring to FIGS. 8 and 9, the delay time information TDOA may be generated for each of signals, for example, S[1,3], S[1,5] and S[3,5], selected among selection sound source signals S[1,3,5]. In some example embodiments, the delay time information receiver 131 may select at least a portion of the delay time information TDOA. In some example embodiments, the second reference level GLR may be determined, predetermined or alternatively, desired based on an output value obtained by applying GCC_PHAT to diffuse noise having no directionality. In some example embodiments, the delay time information receiver 131 may select only delay time information in which the maximum value of each of the delay time information TDOA is greater than the second reference level GLR. In other example embodiments, the delay time information receiver 131 may select only delay time information in which the average value of each of the delay time information TDOA is greater than the second reference level GLR. But the scope of the present inventive concepts is not limited thereto.

The delay time information receiver 131 selects at least a portion of the delay time information TDOA based on the second reference level GLR to generate selection delay time information STDOA, hereinafter, it is assumed that the selection delay time information STDOA include delay time generated for each of S[1,3] and S[3,5]. The delay time information receiver 131 may transmit the selection delay time information to the position parameter provider 133.

The position parameter provider 133 receives the selection delay time information STDOA from the delay time information receiver 131. The position parameter provider 133 generates position parameters PPRM based on the selection delay time information STDOA. In some example embodiments, the position parameters PPRM may include parameters related to a straight line or a curve for modeling a position of the sound source based on the selection delay time information STDOA. In some example embodiments, the position parameters PPRM may include parameters related to a hyperbolic curve, for example, 22a and 22b in case of S[1,3], and 24a and 24b in case of S[3,5], generated based on the selection delay time information STDOA. In some example embodiments, the position parameters PPRM may include position information of each of the microphones corresponding to delay times included in the selection delay time STDOA, position information of focus of the hyperbolic curve and information of asymptote of the hyperbolic curve. But the scope of the present inventive concepts is not limited thereto.

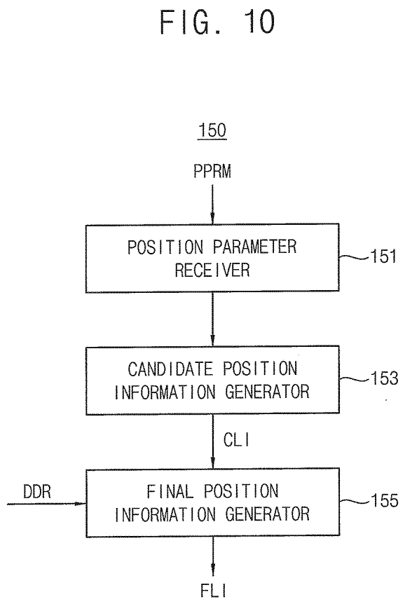

FIG. 10 is a block diagram illustrating an example embodiment of the sound source position information generator of FIG. 3.

Referring to FIG. 10, the sound source position information generator 150 includes position parameter receiver 151, a candidate position information generator 153 and a final position information generator 155.

The position parameter receiver 151 receives and stores the position parameters PPRM from the position parameter generator 130, and transmits the position parameters PPRM to the candidate position information generator 153.

The candidate position information generator 153 receives the position parameters PPRM from the position parameter receiver 151, and generates candidate position information CLI representing candidate positions on which the sound source is expected to be located, based on the position parameters PPRM. In some example embodiments, the candidate position information CLI may include information on an intersection point between hyperbolic curves generated based on the position parameters PPRM. The candidate position information generator 153 transmits the candidate position information CLI to the final position information generator 155.

The final position information generator 155 receives the candidate position information CLI from the candidate position information generator 153 and receives the third reference level DDR from outside (for example, outside the vehicle). The final position information generator 155 generates final position information FLI by selecting at least a portion of the candidate position information CLI based on the third reference level DDR. Hereinafter, a detailed description will be described.

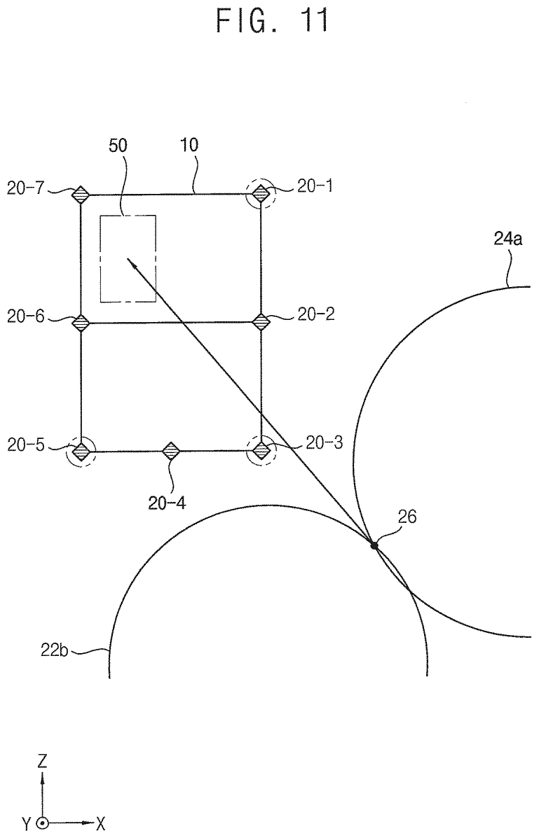

FIG. 11 is a diagram for describing a process of generating final position information by the final position information generator of FIG. 10.

Referring to FIGS. 2 and 11, the final position information generator 155 generates vector information including a starting point corresponding to the final position of the sound source and an end point corresponding to a position of the driver 50, based on the candidate position information CLI and the position of the driver 50. In some example embodiments, the third reference level DDR may be determined, predetermined or alternatively, desired based on a distance between a driving lane and a neighboring lane adjacent to the driving lane in which the vehicle is running. In some example embodiments, the final position information generator 155 may not generate the final position information FLI when a magnitude of a vector according to the vector information is greater than the third reference level DDR. The final position information generator 155 may generate the final position information FLI when a magnitude of a vector according to the vector information is equal or less than the third reference level DDR.

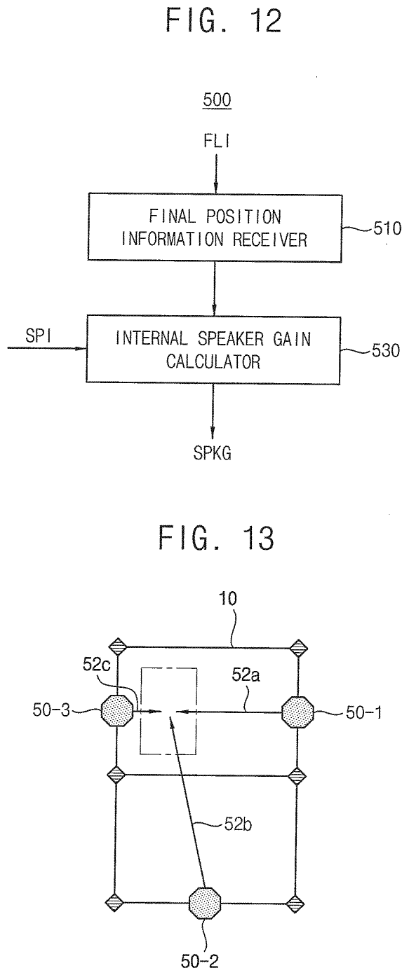

FIG. 12 is a block diagram illustrating an example embodiment of the sound source reproducer of FIG. 1.

Referring to FIG. 12, the sound source reproducer 500 includes a final position information receiver 510 and/or an internal speaker gain calculator 530.

The final position information receiver 510 receives and stores the final position information FLI from the final position information generator 155. The final position information receiver 510 output to the final position information FLI to the internal speaker gain calculator 530.

The internal speaker gain calculator 530 receives the final position information FLI and receives speaker position information SPI from outside (for example, outside the vehicle). The internal speaker gain calculator 530 calculates and outputs the internal speaker gain SPKG based on the final position information FLI and the speaker position information SPI. Hereinafter, a detailed description will be described.

FIG. 13 is a diagram for describing a process of calculating an internal speaker gain.

In FIG. 13, internal speakers 50-1, 50-2 and 50-3 are illustrated. Referring to FIG. 13, speaker position information SPI includes vector information including a starting point corresponding to positions of internal speakers 50-1, 50-2 and 50-3 and an end point corresponding to a position of the driver 50. In some example embodiments, the internal speaker gain SPKG may be calculated according to Equation 4, Equation 5 and Equation 6 below.

$$\begin{matrix}p = {g}_{1} {l}_{1} + {g}_{2} {l}_{2} + {g}_{3} {l}_{3} & [ Equation 4 ] \\ {p}^{T} = {gL}_{123} & [ Equation 5 ] \\ g = {p}^{T} {L}_{123}^{- 1} = {[ {p}_{x} {p}_{y} {p}_{z} ] [ \begin{matrix}{l}_{{1}_{x}} & {l}_{{1}_{y}} & {l}_{{1}_{z}} \\ {l}_{{2}_{x}} & {l}_{{2}_{y}} & {l}_{{2}_{z}} \\ {l}_{{3}_{x}} & {l}_{{3}_{y}} & {l}_{{3}_{z}}\end{matrix} ]}^{- 1} & [ Equation 6 ]\end{matrix}$$

In Equations 4, 5 and 6, the P is a vector representing the final position information FLI, the g is a gain of each of the internal speakers 50-1, 50-2 and 50-3, and the L₁₂₃ is a vector representing the speaker position information SPI.

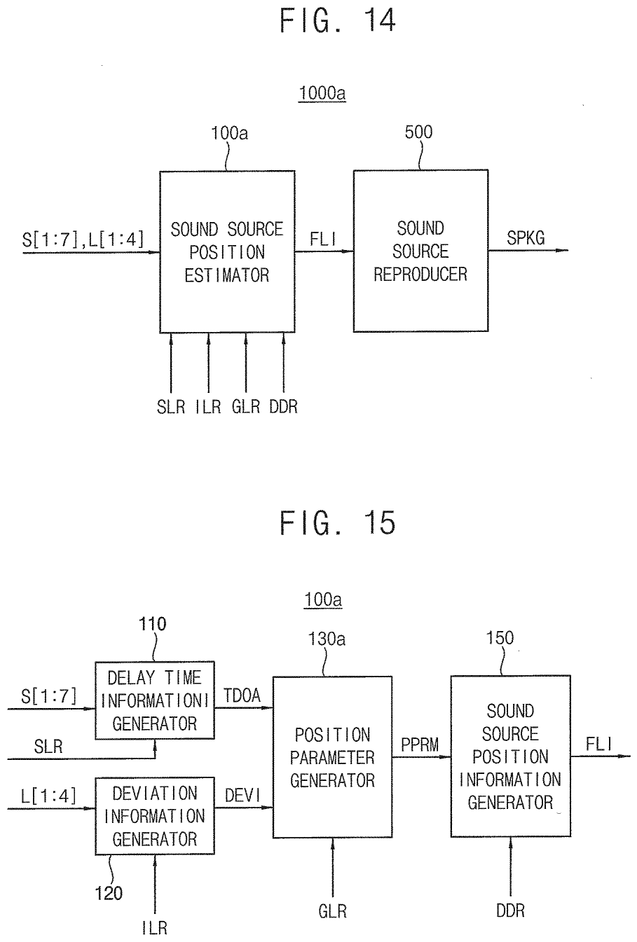

FIG. 14 is a block diagram illustrating an alarm device according to example embodiments.

In the alarm devices 1000 and 1000a illustrated in FIGS. 1 and 14, components using same reference numerals perform similar functions, and thus, redundant descriptions will be omitted below.

Referring to FIGS. 1, 2 and 14, the alarm device 1000a includes a sound source position estimator 100a and/or a sound source reproducer 500.

The sound source position estimator 100a receives sound generated from the sound source 70 outside of the vehicle 10 using a plurality of microphones installed in the vehicle 10. The sound source position estimator 100a receives an external image generated by photographing the outside of the vehicle 10 using a plurality of image sensors installed in the vehicle 10. Each of the plurality of microphones receives the sound and generates sound source signals S[1:7]. Each of the plurality of image sensors receives the external image and generates image signals L[1:4].

The sound source position estimator 100a receives the first reference level SLR, and generates delay time information based on at least a portion of the sound source signals S[1:7] and the first reference level SLR. The sound source position estimator 100a receives the fourth reference level ILR, and generates deviation information DEVI based on at least a portion of the image signals L[1:4] and the fourth reference level ILR.

The sound source position estimator 100a receives the second reference level GLR, and generates position parameters based on at least a portion of the delay time information, the deviation information DEVI and the second reference level GLR. The sound source position estimator 100a generates candidate position information representing candidate positions on which the sound source is expected to be located. The sound source position estimator 100a receives the third reference level DDR, and generates final position information FLI based on at least a portion of the candidate position information and the third reference level DDR.

The sound source reproducer 500 receives the final position information FLI from the sound source position estimator 100a. The sound source reproducer 500 adaptively generates an alarm to the driver 50 by adjusting the internal speaker gain SPKG based on the final position information FLI.

FIG. 15 is a block diagram illustrating an example embodiment of the sound source position estimator of FIG. 14.

Referring to FIG. 15, the sound source position estimator 100a includes a delay time information generator 110, a deviation information generator 120, a position parameter generator 130a and/or a sound source position information generator 150.

The delay time information generator 110 receives sound source signals S[1:7] from each of the plurality of microphones 20-1 to 20-7, and receives a first reference level SLR from outside (for example, outside the vehicle). The delay time information generator 110 generates selection sound source signals by selecting at least a portion of the sound source signals S [1:7]based on the first reference level SLR. The delay time information generator 110 generates spectrum signals by converting the selection sound source signals into a frequency domain. The delay time information generator 110 generates delay time information TDOA by applying a delay time estimation algorithm to the spectrum signals.

The deviation information generator 120 receives image signals L[1:4] from each of the plurality of image sensors, and receives a fourth reference level ILR from outside (for example, outside the vehicle). The deviation information generator 120 generates selection image signals by selecting at least a portion of the image signals L[1:4] based on the fourth reference level. The deviation information generator 120 generates deviation information DEVI based on the selection image signals.

The position parameter generator 130 receives delay time information TDOA from the delay time information generator 110, receives deviation information DEVI from the deviation information generator 120, and receives a second reference level GLR from outside (for example, outside the vehicle). The position parameter generator 130 generates selection delay time information by selecting a portion of the delay time information TDOA and selecting a portion of the deviation information DEVI, based on the second reference level GLR. The position parameter generator 130 generates position parameters PPRM for estimating the position of the sound source based on the selection delay time information.

The sound source position information generator 150 receives the position parameters PPRM from the position parameter generator 130 and receives a third reference level DDR from outside (for example, outside the vehicle). The sound source position information generator 150 generates candidate position information representing candidate positions on which the sound source is expected to be located, selects at least a portion of the candidate position information based on the third reference level DDR to generate final position information FLI.

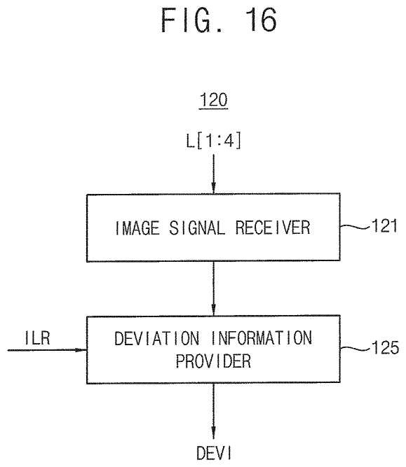

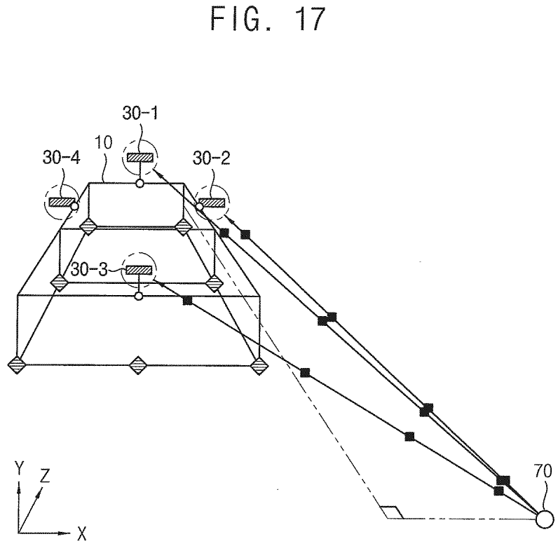

FIG. 16 is a block diagram illustrating an example embodiment of the deviation information generator of FIG. 15.

Referring to FIG. 16, the deviation information generator 120 includes an image signal receiver 121 and/or a deviation information provider 125.

The image signal receiver 121 receives and stores the image signals L[1:4], and transmits the image signals L[1:4] to the deviation information provider 125.

The deviation information provider 125 receives the image signals L[1:4] from the image signal receiver 121 and receives a fourth reference level ILR from outside (for example, outside the vehicle). The deviation information provider 125 selects at least a portion of the image signals L[1:4] based on the fourth reference level ILR. Hereinafter, a detailed description will be described.

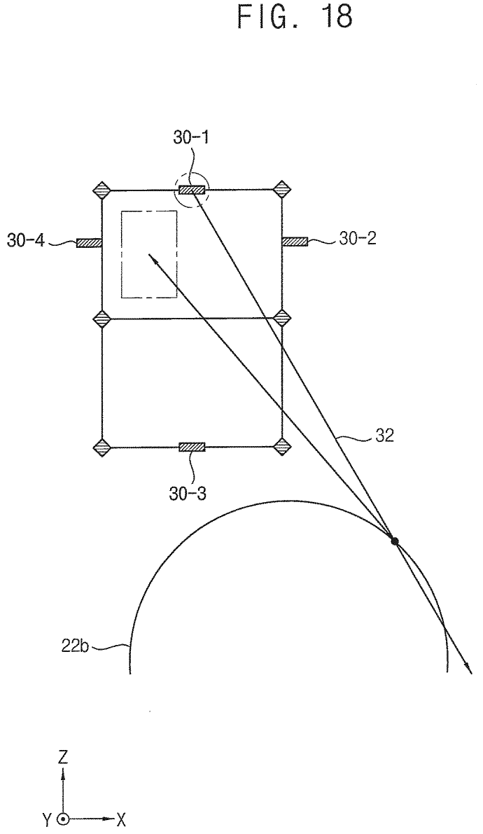

FIG. 17 is a diagram for describing a process of selecting at least a portion of image signals by the deviation information generator of FIG. 16.

In FIG. 17, a front part and a rear part of the vehicle 10 are illustrated. A plurality of image sensors 30-1 to 30-4 may be embedded at a center, a left and right sides of the front part and at a center of the rear part. But a number and embedded positions of the plurality of image sensors 30-1 to 30-4 are examples, and the scope of the present inventive concepts is not limited thereto.

Referring to FIGS. 15 and 17, each of the image signals L[1:4] may represent different image signals due to a relative positions of other vehicle generating a sound source and a plurality of image sensors 30-1 to 30-4. For example, as illustrated in FIG. 17, when other vehicle generating the sound source 70 is located near the rear right side of the vehicle 10, only a portion of image sensors 30-1 to 30-3 may generate image signals including an image of the other vehicle. In some example embodiments, the deviation information generator 120 may select only at least a portion of the image signals L[1:4] based on the fourth reference level ILR. In some example embodiments, the fourth reference level ILR may be determined, predetermined or alternatively, desired in advance based on a change in an average brightness value of each of the image signals L[1:4] when the other vehicle appears in an adjacent lane. In some example embodiments, the deviation information generator 120 may select only image signals in which a change in brightness value of each of the image signals L[1:4] is greater than the fourth reference level ILR. But the scope of the present inventive concepts is not limited thereto.

The deviation information generator 120 may generate deviation information DEVI representing a distance between the other vehicle and the image sensors based on the image signals L[1:3].

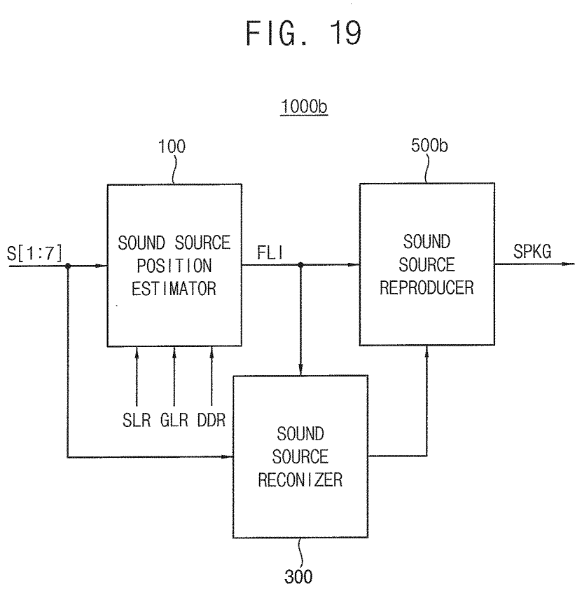

FIG. 18 is a diagram for describing a process of generating position parameters by the position parameter generator of FIG. 15 and a process of generating final position information by sound source position information generator of FIG. 15.

Referring to FIG. 18, the position parameter generator 130a receives delay time information TDOA from the delay time information generator 110, receives deviation information DEVI from the deviation information generator 120 and receives a second reference level GLR from outside (for example, outside the vehicle).

The position parameter generator 130a generates position parameters PPRM for estimating the position of a sound source based on the second reference level GLR, delay time information TDOA and deviation information DEVI. In some example embodiments, the position parameters PPRM may include parameters related to a hyperbolic curve generated based on the delay time information TDOA and a straight line generated based on the deviation information DEVI. For example, the position parameters PPRM may include position information of each of the microphones corresponding to delay times included in the delay time information, position information of focus of the hyperbolic curve and information of asymptote of the hyperbolic curve. Further, the position parameters PPRM may include information about a distance between the other vehicle and the image sensors included in the deviation information DEVI, the position information of each of the image sensors, and information about the slope of the straight line 32. But the scope of the present inventive concepts is not limited thereto.

The sound source position information generator 150 receives position parameters PPRM from the position parameter generator 130a, and generates candidate position information representing candidate positions on which the sound source is expected to be located, based on the position parameters PPRM. In some example embodiments, the candidate position information may be generated by obtaining an intersection point between the hyperbolic curve 22b and the straight line 32 generated based on the position parameters PPRM. The sound source position information generator 150 generates final location information FLI by selecting at least a portion of the candidate position information based on the third reference level DDR.

FIG. 19 is a block diagram illustrating an alarm device according to example embodiments.

Referring to FIGS. 1, 2 and 19, the alarm device 1000b includes a sound source position estimator 100, a sound source recognizer 300 and/or a sound source reproducer 500b.

The sound source position estimator 100 receives the first reference level SLR and generates delay time information based on at least a portion of the sound source signal S[1:7] and the first reference level SLR. The sound source position estimator 100 receives the second reference level GLR and generates position parameters based on at least a portion of the delay time information and the second reference level GLR. The sound source position estimator 100 generates candidate position information representing candidate positions on which the sound source is expected to be located. The sound source position estimator 100 receives the third reference level DDR, and generates final position information FLI based on at least a portion of the candidate position information and the third reference level DDR.

The sound source recognizer 300 receives sound source signals S[1:7], and receives final position information FLI from the sound source position estimator 100. The sound source recognizer 300, based on the sound source signals and the final position information, may transmit only sound source signal corresponding to the microphone closest to a position of sound source determined based on the final position information among sound source signals to the sound source reproducer 500b.

The sound source reproducer 500 receives the final position information FLI from the sound source position estimator 100. The sound source reproducer 500 adaptively generates an alarm to the driver 50 by adjusting an internal speaker gain SPKG based on the final position information FLI.

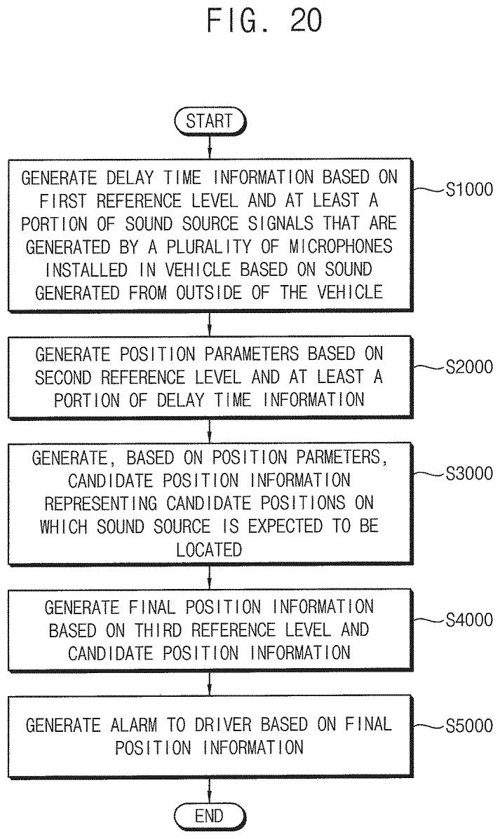

FIG. 20 is a flowchart illustrating a method of operating an alarm device according to example embodiments.

Referring to FIG. 20, delay time information is generated based on a first reference level and at least a portion of sound source signals generated from each of the plurality of microphones (S1000). Position parameters are generated based on a second reference level and at least a portion of delay time information (S2000). Candidate position information representing candidate positions on which the sound source is expected to be located (S3000). Final position information is generated based on a third reference level and at least a portion of candidate position information (S4000). An alarm is generated to the driver based on the final position information (S5000).

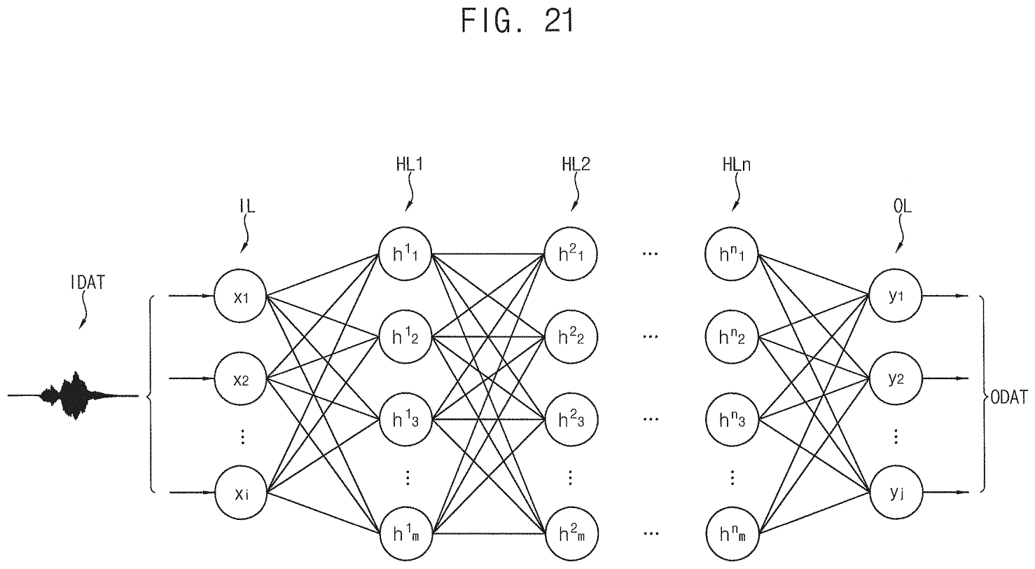

FIGS. 21, 22 and 23 are diagrams for describing an example embodiment of a network structure used to perform deep learning for recognizing a type of sound source by an alarm device according to example embodiments.

Referring to FIG. 21, a general neural network (e.g., an ANN) may include an input layer IL, a plurality of hidden layers HL1, HL2, . . . , HLn and an output layer OL.

The input layer IL may include i input nodes x₁, x₂, . . . , xᵢ, where i is a natural number. Input data (e.g., vector input data) IDAT whose length is i may be input to the input nodes x₁, x₂, . . . , xᵢ such that each element of the input data IDAT is input to a respective one of the input nodes x₁, x₂, . . . , xᵢ.

The plurality of hidden layers HL1, HL2, . . . , HLn may include n hidden layers, where n is a natural number, and may include a plurality of hidden nodes h¹₁, h¹₂, h¹₃, . . . , h¹ₘ, h²₁, h²₂, h²₃, . . . , h²ₘ, hⁿ₁, hⁿ₂, hⁿ₃, . . . , hⁿₘ. For example, the hidden layer HL1 may include m hidden nodes h¹₁, h¹₂, h¹₃, . . . , h¹ₘ, the hidden layer HL2 may include m hidden nodes h²₁, h²₂, h²₃, . . . , h²ₘ, and the hidden layer HLn may include m hidden nodes hⁿ₁, hⁿ₂, hⁿ₃, . . . , hⁿₘ, where m is a natural number.

The output layer OL may include j output nodes y₁, y₂, . . . , yⱼ, where j is a natural number. Each of the output nodes y₁, y₂, . . . , yⱼ may correspond to a respective one of classes to be categorized. The output layer OL may output output values (e.g., class scores or simply scores) associated with the input data IDAT for each of the classes. The output layer OL may be referred to as a fully-connected layer and may indicate, for example, a probability that the input data IDAT corresponds to a car.

A structure of the neural network illustrated in FIG. 21 may be represented by information on branches (or connections) between nodes illustrated as lines, and a weighted value assigned to each branch, which is not illustrated. Nodes within one layer may not be connected to one another, but nodes of different layers may be fully or partially connected to one another.

Each node (e.g., the node h¹₁) may receive an output of a previous node (e.g., the node x₁), may perform a computing operation, computation or calculation on the received output, and may output a result of the computing operation, computation or calculation as an output to a next node (e.g., the node h²₁). Each node may calculate a value to be output by applying the input to a specific function, e.g., a nonlinear function.

Generally, the structure of the neural network is set in advance, and the weighted values for the connections between the nodes are set appropriately using data having an already known answer of which class the data belongs to. The data with the already known answer is referred to as “training data,” and a process of determining the weighted value is referred to as “training.” The neural network “learns” during the training process. A group of an independently trainable structure and the weighted value is referred to as a “model,” and a process of predicting, by the model with the determined weighted value, which class the input data belongs to, and then outputting the predicted value, is referred to as a “testing” process.

The general neural network illustrated in FIG. 21 may not be suitable for handling input image data (or input sound data) because each node (e.g., the node h¹₁) is connected to all nodes of a previous layer (e.g., the nodes x₁, x₂, . . . , xᵢ included in the layer IL) and then the number of weighted values drastically increases as the size of the input image data increases. Thus, a convolution neural network (CNN), which is implemented by combining the filtering technique with the general neural network, has been researched such that two-dimensional image (e.g., the input image data) is efficiently trained by the CNN.

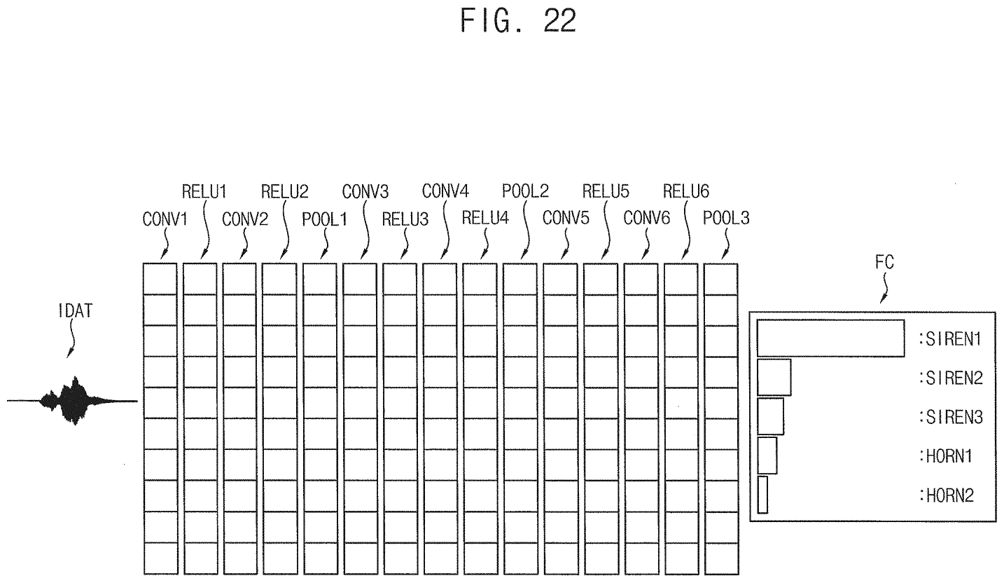

Referring to FIG. 22, a CNN may include a plurality of layers CONV1, RELU1, CONV2, RELU2, POOL1, CONV3, RELU3, CONV4, RELU4, POOL2, CONV5, RELU5, CONV6, RELU6, POOL3 and FC.

Unlike the general neural network, each layer of the CNN may have three dimensions of width, height and depth, and thus data that is input to each layer may be volume data having three dimensions of width, height and depth. For example, if an input image in FIG. 22 has a size of 32 widths (e.g., 32 pixels) and 32 heights and three color channels R, G and B, input data IDAT corresponding to the input image may have a size of 32*32*3. The input data IDAT in FIG. 22 may be referred to as input volume data or input activation volume.

Each of convolutional layers CONV1, CONV2, CONV3, CONV4, CONV5 and CONV6 may perform a convolutional operation on input volume data. In an image processing, the convolutional operation represents an operation in which image data is processed based on a mask with weighted values and an output value is obtained by multiplying input values by the weighted values and adding up the total multiplied values. The mask may be referred to as a filter, window or kernel.

For example, parameters of each convolutional layer may include a set of learnable filters. Every filter may be small spatially (along width and height), but may extend through the full depth of an input volume. For example, during the forward pass, each filter may be slid (more precisely, convolved) across the width and height of the input volume, and dot products may be computed between the entries of the filter and the input at any position. As the filter is slid over the width and height of the input volume, a two-dimensional activation map that gives the responses of that filter at every spatial position may be generated. As a result, an output volume may be generated by stacking these activation maps along the depth dimension. For example, if input volume data having a size of 32*32*3 passes through the convolutional layer CONV1 having four filters with zero-padding, output volume data of the convolutional layer CONV1 may have a size of 32*32*12 (e.g., a depth of volume data increases).

Each of RELU layers RELU1, RELU2, RELU3, RELU4, RELU5 and RELU6 may perform a rectified linear unit (RELU) operation that corresponds to an activation function defined by, e.g., a function f(x)=max(0, x) (e.g., an output is zero for all negative input x). For example, if input volume data having a size of 32*32*12 passes through the RELU layer RELU1 to perform the rectified linear unit operation, output volume data of the RELU layer RELU1 may have a size of 32*32*12 (e.g., a size of volume data is maintained).

Each of pooling layers POOL1, POOL2 and POOL3 may perform a down-sampling operation on input volume data along spatial dimensions of width and height. For example, four input values arranged in a 2*2 matrix formation may be converted into one output value based on a 2*2 filter. For example, a maximum value of four input values arranged in a 2*2 matrix formation may be selected based on 2*2 maximum pooling, or an average value of four input values arranged in a 2*2 matrix formation may be obtained based on 2*2 average pooling. For example, if input volume data having a size of 32*32*12 passes through the pooling layer POOL1 having a 2*2 filter, output volume data of the pooling layer POOL1 may have a size of 16*16*12 (e.g., width and height of volume data decreases, and a depth of volume data is maintained).

Typically, one convolutional layer (e.g., CONV1) and one RELU layer (e.g., RELU1) may form a pair of CONV/RELU layers in the CNN, pairs of the CONV/RELU layers may be repeatedly arranged in the CNN, and the pooling layer may be periodically inserted in the CNN, thereby reducing a spatial size of image and extracting a characteristic of image.

An output layer or a fully-connected layer FC may output results (e.g., class scores) of the input volume data IDAT for each of the classes. For example, the input volume data IDAT corresponding to the two-dimensional image may be converted into an one-dimensional matrix or vector as the convolutional operation and the down-sampling operation are repeated. For example, the fully-connected layer FC may represent probabilities that the input volume data IDAT corresponds to a car, a truck, an airplane, a ship and a horse.

The types and number of layers included in the CNN may not be limited to an example described with reference to FIG. 22 and may be changed according to example embodiments. In addition, although not illustrated in FIG. 22, the CNN may further include other layers such as a softmax layer for converting score values corresponding to predicted results into probability values, a bias adding layer for adding at least one bias, or the like.

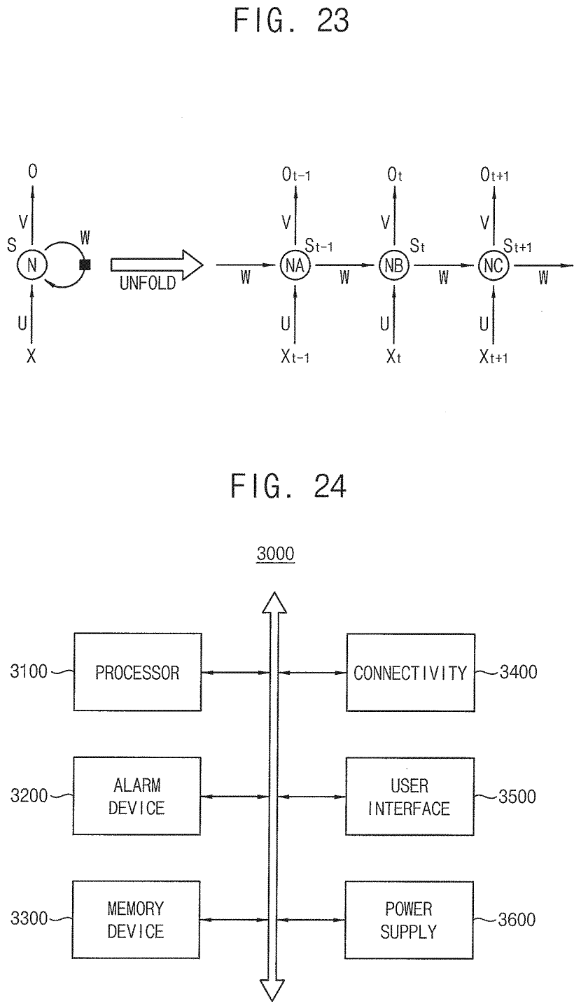

Referring to FIG. 23, a recursive neural network (RNN) may include a repeating structure using a specific node or cell N illustrated on the left side of FIG. 23.

A structure illustrated on the right side of FIG. 23 may represent that a recurrent connection of the RNN illustrated on the left side is unfolded (or unrolled). The term “unfolded” means that the network is written out or illustrated for the complete or entire sequence including all nodes NA, NB and NC. For example, if the sequence of interest is a sentence of 3 words, the RNN may be unfolded into a 3-layer neural network, one layer for each word (e.g., without recurrent connections or without cycles).

In the RNN in FIG. 23, X represents an input of the RNN. For example, Xₜ may be an input at time step t, and Xₜ₋₁ and Xₜ₊₁ may be inputs at time steps t−1 and t+1, respectively.

In the RNN in FIG. 23, S represents a hidden state. For example, Sₜ may be a hidden state at the time step t, and Sₜ₋₁ and Sₜ₊₁ may be hidden states at the time steps t−1 and t+1, respectively. The hidden state may be calculated based on a previous hidden state and an input at a current step. For example, Sₜ=f(UXₜ+WSₜ₋₁). For example, the function f may be usually a nonlinearity function such as tan h or RELU. S₋₁, which is required to calculate a first hidden state, may be typically initialized to all zeroes.

In the RNN in FIG. 23, O represents an output of the RNN. For example, Oₜ may be an output at the time step t, and Oₜ₋₁ and Oₜ₊₁ may be outputs at the time steps t−1 and t+1, respectively. For example, if it is required to predict a next word in a sentence, it would be a vector of probabilities across a vocabulary. For example, Ot=softmax(VSt).

In the RNN in FIG. 23, the hidden state may be a “memory” of the network. In other words, the RNN may have a “memory” which captures information about what has been calculated so far. The hidden state Sₜ may capture information about what happened in all the previous time steps. The output Ot may be calculated solely based on the memory at the current time step t. In addition, unlike a traditional neural network, which uses different parameters at each layer, the RNN may share the same parameters (e.g., U, V and W in FIG. 21) across all time steps. This may represent the fact that the same task may be performed at each step, just with different inputs. This may greatly reduce the total number of parameters required to be trained or learned.

The network structure may utilize a variety of other artificial neural network organizational and processing models, such as deconvolutional neural networks, recurrent neural networks (RNN) including long short-term memory (LSTM) units and/or gated recurrent units (GRU), stacked neural networks (SNN), state-space dynamic neural networks (SSDNN), deep belief networks (DBN), generative adversarial networks (GANs), and/or restricted Boltzmann machines (RBM).

Alternatively or additionally, such network structures may include other forms of machine learning models, such as, for example, linear and/or logistic regression, statistical clustering, Bayesian classification, decision trees, dimensionality reduction such as principal component analysis, and expert systems; and/or combinations thereof, including ensembles such as random forests. Such machine learning models may also be used to provide various services and/or applications, e.g., an image classify service, a user authentication service based on bio-information or biometric data, an advanced driver assistance system (ADAS) service, a voice assistant service, an automatic speech recognition (ASR) service, or the like, may be performed, executed or processed by electronic devices.

FIG. 24 is a block diagram illustrating a client including an alarm device according to example embodiments.

Referring to FIG. 24, the client 3000 includes a processor 3100, an alarm device 3200, a memory device 3300, a connectivity unit 3400, a user interface 3500 and/or a power supply 3600.

The client 3000 may be the vehicle 10 described above with reference to FIGS. 2, 5, 9 and 11. The processor 3100 controls an overall operation of the client 3000, executes an operating system, an application, etc., and executes various computing functions such as specific calculations or tasks. The communication unit 3400 may communicate with an external device. The memory device 3300 may store data processed by the processor 3100 or may operate as a working memory. The user interface 3500 may include one or more input devices such as keypads, buttons, microphones, and touch screens, and/or one or more output devices such as speakers and display devices. The power supply 3600 may supply an operating voltage of the client 3000. The alarm device 3200 may generate the above-described alarm with reference to FIG. 1 and the like.

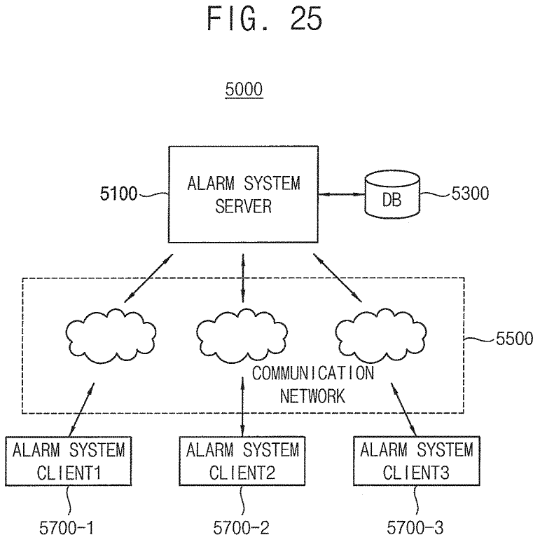

FIG. 25 is a block diagram illustrating an alarm system including an alarm device according to example embodiments.

Referring to FIG. 25, an alarm system 5000 includes an alarm system server 5100, a database 5300, a communication network 5500 and/or one or more alarm system clients 5700-1, 5700-2 and 5700-3.

At least one of the alarm system clients 5700-1, 5700-2 and 5700-3 may include one of the above-described alarm devices 1000, 1000a and 1000b with reference to FIGS. 1, 14 and 19. The alarm system clients 5700-1, 5700-2 and 5700-3 may include computing devices or communication terminals having a communication function, and may include mobile phones, smart phones, tablet PCs, mobile internet devices MIDs, internet tablets, and IoT (Internet of Things) device, or a wearable computer, but the scope of the present inventive concepts is not limited thereto.

The communication network 5500 includes a local area network LAN, a wide area network WAN, an Internet WWW, a wired/wireless data communication network, a telephone network, a wired/wireless television communication network, and the like.

The wireless communication network may be one of a 3G, a 4G, a 5G, a 3GPP (3rd Generation Partnership Project), a LTE (Long Term Evolution), a WIMAX (World Interoperability for Microwave Access), a WiFi, a Bluetooth communication, an infrared communication, an ultrasonic communication, a Visible Light Communication VLC and a Li-Fi, but the scope of the present inventive concepts is not limited thereto.

Any of the elements disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

As described above, the alarm device, the alarm system including the alarm device, and the alarm method according to example embodiments of the present inventive concepts may adaptively send an alarm to the driver who boarded the vehicle according to the type of the sound source generated from outside (for example, outside the vehicle) using visual and audible devices. Therefore, the alarm device, the alarm system and the alarm method allow the driver to drive safely. Further, the alarm device, alarm system and alarm method receive the first to third reference levels and select at least a portion of the corresponding signals or information based on each of the first to third reference levels. The alarm device, the alarm system and the alarm method may reduce power consumption by performing subsequent processing for only a portion of the signals or the information according to the selection.

The inventive concepts may be applied to various types of vehicles and, when a driver of the vehicles is a hearing impaired person, enables the driver to safely drive by adaptively generating an alarm to the driver using visual and audio devices.

The foregoing is illustrative of example embodiments and is not to be construed as limiting thereof. Although a few example embodiments have been described, those skilled in the art will readily appreciate that many modifications are possible in the example embodiments without materially departing from the present inventive concepts.

What is claimed is:

1. An alarm device configured to generate an alarm to a driver inside a vehicle, the alarm device comprising:
processing circuitry configured to:
generate delay time information based on a first reference level and at least a portion of sound source signals that are generated by a plurality of microphones in the vehicle based on a sound generated from outside of the vehicle;
generate position parameters based on a second reference level and at least a portion of the delay time information; and
generate, based on the position parameters, candidate position information representing candidate positions on which the sound source is expected to be located, and generate final position information based on a third reference level and the candidate position information.

2. The alarm device of claim 1, wherein the first reference level is determined based on strength of a siren or a horn sound of vehicles, the second reference level is determined based on an output value obtained by applying GCC_PHAT (Generalized Cross Correlation-Phase Transform) to diffuse noise having no directionality, and the third reference level is determined based on a distance between a driving lane on which the vehicle is running and a neighboring lane adjacent to the driving lane.

3. The alarm device of claim 1, wherein the processing circuitry is further configured to:
receive and store the sound source signals; and
receive the first reference level from outside the vehicle and select at least a portion of the sound source signals based on the first reference level.

4. The alarm device of claim 1, wherein the processing circuitry is further configured to:
receive the delay time information and the second reference level, and generate selection delay time information by selecting at least a portion of the delay time information based on the second reference level; and
generate a position parameters based on the selection delay time.

5. The alarm device of claim 1, wherein the processing circuitry is further configured to:
receive and store the position parameters,
generate, based on the position parameters, the candidate position information representing candidate positions on which the sound source is expected to be located; and
select a final position of the sound source among the candidate positions based on the third reference level.

6. The alarm device of claim 5, wherein the processing circuitry is further configured to generate vector information including a starting point corresponding to the final position of the sound source and an end point corresponding to a position of the driver.

7. The alarm device of claim 6, wherein the processing circuitry is further configured to generate the vector information as the final position information only when a magnitude of a vector according to the vector information is less than or equal to the third reference level.

8. The alarm device of claim 1, wherein the processing circuitry is further configured to:
generate an alarm to the driver inside the vehicle by receiving and storing the final position information and receiving speaker position information from outside the vehicle, calculating an internal speaker gain based on the final position information and the speaker position information and outputting the internal speaker gain.

9. The alarm device of claim 8, wherein the processing circuitry is further configured to:
receive the sound source signals and the final position information, and transmit only a sound source signal corresponding to a microphone closest to a position according to the final position information among the sound source signals based on the sound source signals and the final position information.

10. The alarm device of claim 1, wherein the processing circuitry is further configured to:
receive image signals from each of a plurality of image sensors and to receive a fourth reference level from outside the vehicle.

11. The alarm device of claim 10, wherein the processing circuitry is further configured to select at least a portion of the image signals based on the fourth reference level to generate selected image signals, and configured to generate deviation information based on the selected image signals.

12. The alarm device of claim 11, wherein the fourth reference level is determined based on a change in an average brightness value of each of the image signals when another vehicle appears in a neighboring lane adjacent to a driving lane in which the vehicle is running.

13. An alarm system comprising:
an alarm system server; and
one or more alarm system clients configured to request a service to the alarm system server,
wherein each of the alarm system clients includes an alarm device, the alarm device comprising:
processing circuitry configured to:
generate delay time information based on a first reference level and at least a portion of sound source signals that are generated by a plurality of microphones in a vehicle based on a sound generated from outside of the vehicle;
generate position parameters based on a second reference level and at least a portion of the delay time information; and
generate, based on the position parameter, candidate position information representing candidate positions on which the sound source is expected to be located, and generate final position information based on a third reference level and the candidate position information.

14. The alarm system of claim 13, wherein the first reference level is determined based on strength of a siren or a horn sound of vehicles, the second reference level is determined based on an output value obtained by applying GCC_PHAT(Generalized Cross Correlation-Phase Transform) to diffuse noise having no directionality, and the third reference level is determined based on a distance between a driving lane on which the vehicle is running and a neighboring lane adjacent to the driving lane.

15. The alarm system of claim 13, wherein the processing circuitry is further configured to receive image signals from each of a plurality of image sensors and to receive a fourth reference level from outside the vehicle.

16. The alarm system of claim 15, wherein the processing circuitry is further configured to select at least a portion of the image signals based on the fourth reference level to generate selected image signals and generate deviation information based on the selected image signals.

17. The alarm system of claim 13, wherein the processing circuitry is further configured to:
receive and store the position parameters,
generate, based on the position parameters, the candidate position information representing candidate positions on which the sound source is expected to be located; and
select a final position of the sound source among the candidate positions based on the third reference level.

18. The alarm device of claim 17, wherein the processing circuitry is further configured to generate vector information including a starting point corresponding to the final position of the sound source and an end point corresponding to a position of a driver.

19. A method of generating an alarm to a driver inside a vehicle, the method comprising:
generating delay time information based on a first reference level and at least a portion of sound source signals that are generated by a plurality of microphones in the vehicle based on a sound generated from outside of the vehicle;
generating position parameters based on a second reference level and at least a portion of the delay time information;
generating, based on the position parameters, candidate position information representing candidate positions on which the sound source is expected; and
generating final position information based on a third reference level and the candidate position information.

20. The method of claim 19, wherein the first reference level is determined based on strength of a siren or a horn sound of vehicles, the second reference level is determined based on an output value obtained by applying GCC_PHAT(Generalized Cross Correlation-Phase Transform) to diffuse noise having no directionality, and the third reference level is determined based on a distance between a driving lane on which the vehicle is running and a neighboring lane adjacent to the driving lane.
